(19) United States
(12) Patent Application Publication
(10) Pub. No.: US 2016/0381547 A1
(43) Pub. Date: Dec. 29, 2016

(54) PROFILE-BASED DATA CONNECTION MANAGEMENT

(71) Applicant: QUALCOMM Incorporated, San Diego, CA (US)

(72) Inventors: Sachin JAIN, Santa Clara, CA (US); Ashish MALIK, San Diego, CA (US)

(21) Appl. No.: 14/859,357

(22) Filed: Sep. 21, 2015

Related U.S. Application Data
(60) Provisional application No. 62/185,683, filed on Jun. 28, 2015.

(51) Int. Cl. H04W 8/02; H04W 4/00; H04L 29/08

(52) U.S. Cl. CPC H04W 8/02; H04L 67/306; H04W 4/003

(57) ABSTRACT

Data connection management in a mobile device is achieved by selectively allowing and denying data access to applications installed on the mobile device based on certain conditions, for example, when the mobile device is roaming, when the battery power is low, or when the data usage has exceeded a limit

### CLAIM OF PRIORITY UNDER 35 U.S.C. §119

The present Application for Patent claims priority to Provisional Application No. 62/185,683, entitled “PROFILE-BASED DATA CONNECTION MANAGEMENT,” filed Jun. 28, 2015, and assigned to the assignee hereof and hereby expressly incorporated by reference herein.

### FIELD OF DISCLOSURE

Various embodiments described herein relate to data connection management, and more particularly, to data connection management in mobile devices.

### BACKGROUND

Mobile device users have been able to access voice and data by roaming on non-home carrier networks, including cellular networks or wireless local area networks (WLAN), such as Wi-Fi. When a user roams on a non-home network at locations where access to the user's home network is not available, the roaming charges may be outside of the user's regular subscription plan. When the user is on international travel, for example, roaming a foreign cellular network may often be costly. Data access in international roaming may be very expensive as the user may be charged a price based on the amount of data transferred. Even in some locations with Wi-Fi access, for example, in some hotels, the user may also be charged a fee based on the amount of data transferred. International data roaming charges by some carriers are measured on a per- kilobyte basis. The amount of data transferred, either upstream or downstream, usually depends on the type of data access. For example, a typical email without attachment may involve a transfer of data of only a few kilobytes or a few tens of kilobytes, whereas just one minute of streaming video may involve a transfer of several megabytes of data, depending on the resolution of the video.

When a mobile device user enters a foreign country or turns on the mobile device upon arriving at a foreign airport, for example, all applications on the mobile device may automatically synchronize data on a foreign wireless network. Mobile applications are typically designed by default to synchronize data once data access is available. Even mobile applications that are merely running in the background are typically designed to synchronize data automatically upon power-on and also periodically as long as the device maintains a data connection. A typical modern mobile smartphone may have a large number of applications installed, and some of these applications may require transfers of large amounts of data upon synchronization. For example, applications such as Facebook®, WhatsApp®, or applications for news updates or videos, may require large amounts of data transfer and incur significant data usage costs upon synchronization in a roaming network.

On international business travel, non-critical or non-business-related data usage due to automatic synchronizations of various applications on a mobile device may quickly add up, thereby resulting in a large roaming bill that may be difficult to explain to the management or finance departments. On international personal travel, a tourist also may not wish to pay expensive roaming charges, especially if such charges are due to data usages caused by automatic synchronizations by various applications running in the background when those applications are not even actively used by the tourist. Moreover, many mobile applications perform automatic synchronizations not only when the device is powered on, but also periodically as long as the device is wirelessly connected to a network, regardless of whether the device is roaming.

In order to reduce the amount of data usage caused by automatic synchronization, the mobile device user may open each application and manually turn off the automatic or periodic synchronization feature in that application. However, because a mobile device may have a large number of applications installed, manually turning on or off the automatic or periodic synchronization feature in each application may be a cumbersome process for the user.

Moreover, in some scenarios, a mobile device may have limited remaining battery power, and battery charging may not always be conveniently available. If the mobile device user only wishes to turn on the device in order to use a limited number of applications, for example, to check emails or flight status, which typically involves only a limited amount of data transfer, other applications not being actively used by the mobile device user would automatically perform data synchronizations while the device is on, thereby draining additional battery power.

### SUMMARY

Exemplary embodiments of the disclosure are directed to method and apparatus for data connection management in a mobile device to selectively control data access by applications based on stored profiles. In an embodiment, notifications of data availability with different applications are shared or blocked based on profile selection are provided. In an embodiment, profile selections based on different events, for example, roaming outside the home network, low battery power, data usage limit, or some other event that would make unrestricted data access expensive or undesirable, are provided to allow or deny data access by specific applications on the mobile device.

In an embodiment, a method of selectively controlling data access by a mobile device that stores multiple applications is provided, the method comprising receiving at least one data connection availability event; selecting a profile from multiple profiles based on the data connection availability event, wherein one or more of the profiles is associated with at least one characteristic of data access that permits a first set of the applications to access a given data connection and that does not permit a second set of applications to access the given data connection; allowing data access to the given data connection by at least one of the applications in the first set of applications based on the profile selected; and denying data access to the given data connection by one or more applications in the second set of applications based on the profile selected.

In another embodiment, a wireless device that stores multiple applications is provided, the wireless device comprising means for receiving at least one data connection availability event; means for selecting a profile from multiple profiles based on the data connection availability event, wherein one or more of the profiles is associated with at least one characteristic of data access that permits a first set of the applications to access a given data connection and that does not permit a second set of applications to access the given data connection; means for allowing data access to the given data connection by at least one of the applications in the first set of applications based on the profile selected; and means for denying data access to the given data connection by one or more applications in the second set of applications based on the profile selected.

In another embodiment, a non-transitory computer readable medium in a mobile device that stores multiple applications is provided, the non-transitory computer readable medium comprising instructions for causing a processor to perform operations, the instructions comprising instructions to receive at least one data connection availability event; instructions to select a profile from multiple profiles based on the data connection availability event, wherein one or more of the profiles is associated with at least one characteristic of data access that permits a first set of the applications to access a given data connection and that does not permit a second set of applications to access the given data connection; instructions to allow data access to the given data connection by at least one of the applications in the first set of applications based on the profile selected; and instructions to deny data access to the given data connection by one or more applications in the second set of applications based on the profile selected.

In yet another embodiment, a mobile device that stores multiple applications is provided, the mobile device comprising a memory; and a processor coupled to the memory, the processor comprising logic configured to receive at least one data connection availability event; logic configured to select a profile from multiple profiles based on the data connection availability event, wherein one or more of the profiles is associated with at least one characteristic of data access that permits a first set of the applications to access a given data connection and that does not permit a second set of applications to access the given data connection; logic configured to allow data access to the given data connection by at least one of the applications in the first set of applications based on the profile selected; and logic configured to deny data access to the given data connection by one or more applications in the second set of applications based on the profile selected.

Various embodiments of the disclosure are described in further detail in Detailed Description below.

### BRIEF DESCRIPTION OF THE DRAWINGS

The accompanying drawings are presented to aid in the description of embodiments of the disclosure and are provided solely for illustration of the embodiments and not limitations thereof.

FIG. 1 illustrates a high-level system architecture of a wireless communications system in accordance with an embodiment.

FIG. 2 is a block diagram illustrating an example of a mobile device.

FIG. 3 is a block diagram illustrating an example of profile-based data connection management for a mobile device.

FIG. 4 is a block diagram illustrating an example of profile-based data connection management after a roaming profile has been selected.

FIG. 5 is a flow chart illustrating an embodiment of a process of data connection management.

FIG. 6 is a diagram illustrating an embodiment of profile transitions in data connection management.

FIG. 7 illustrates a mobile device that includes logic configured to perform functionality in accordance with an embodiment.

### DETAILED DESCRIPTION

Aspects of the disclosure are described in the following description and related drawings directed to specific embodiments. Alternate embodiments may be devised without departing from the scope of the disclosure. Additionally, well-known elements will not be described in detail or will be omitted so as not to obscure the relevant details of the disclosure.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” or “including,” when used herein, specify the presence of stated features, integers, steps, operations, elements, and/or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to,” or “in communication with” are not limited to direct connections unless expressly stated otherwise.

Further, many embodiments are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

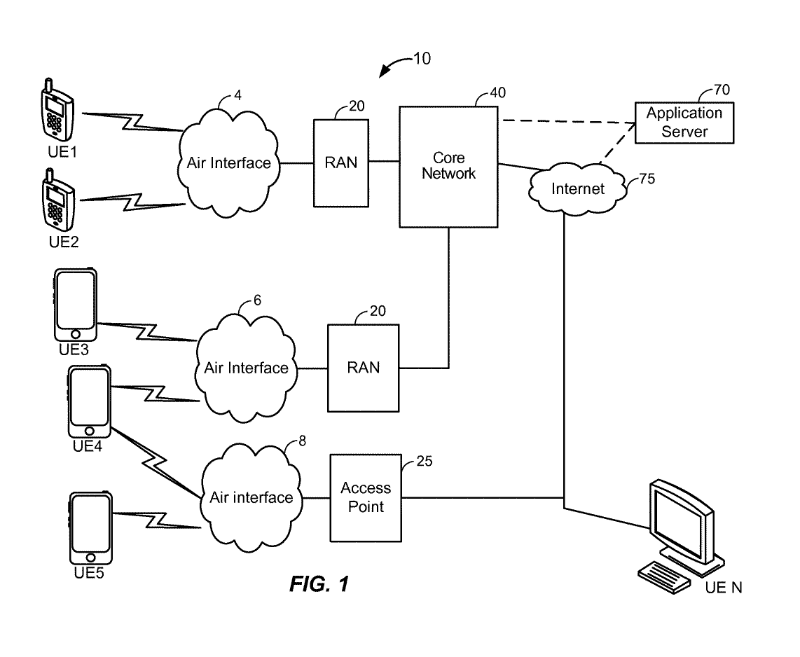

FIG. 1 illustrates a high-level system architecture of a wireless communications system 10 in accordance with an embodiment. The wireless communications system 10 contains mobile devices, also called user equipment UE 1 . . . UE N. The UE 1 . . . UE N can include cellular telephones, personal digital assistant (PDAs), pagers, a laptop computer, a desktop computer, and so on. For example, in FIG. 1, UE 1 . . . UE 2 are illustrated as cellular telephones, UE 3 . . . UE5 are illustrated as cellular touchscreen phones or smart phones, and UE N is illustrated as a desktop computer or PC.

Referring to FIG. 1, UEs 1 . . . N are configured to communicate with an access network (e.g., the radio access network RAN 20, an access point 25, etc.) over a physical communications interface or layer, shown in FIG. 1 as air interfaces 4, 6, 8 and/or a direct wired connection. The air interfaces 4 and 6 can comply with a given cellular communications protocol (e.g., CDMA, EVDO, eHRPD, GSM, EDGE, W-CDMA, LTE, etc.), while the air interface 8 can comply with a wireless IP protocol (e.g., IEEE 802.11). The RAN 20 includes a plurality of access points that serve UEs over air interfaces, such as the air interfaces 4 and 6. The access points in the RAN 20 can be referred to as access nodes or ANs, access points or APs, base stations or BSs, Node Bs, eNode Bs, and so on. These access points can be terrestrial access points (or ground stations), or satellite access points. The RAN 20 is configured to connect to a core network 40 that can perform a variety of functions, including bridging circuit switched (CS) calls between UEs served by the RAN 20 and other UEs served by the RAN 20 or a different RAN altogether, and can also mediate an exchange of packet-switched (PS) data with external networks such as Internet 75. The Internet 75 includes a number of routing agents and processing agents (not shown in FIG. 1 for the sake of convenience). In FIG. 1, UE N is shown as connecting to the Internet 75 directly (i.e., separate from the core network 40, such as over an Ethernet connection of WiFi or 802.11-based network). The Internet 75 can thereby function to bridge packet-switched data communications between UE N and UEs 1 . . . N via the core network 40. Also shown in FIG. 1 is the access point 25 that is separate from the RAN 20. The access point 25 may be connected to the Internet 75 independent of the core network 40 (e.g., via an optical communication system such as FiOS, a cable modem, etc.). The air interface 8 may serve UE 4 or UE 5 over a local wireless connection, such as IEEE 802.11 in an example. UE N is shown as a desktop computer with a wired connection to the Internet 75, such as a direct connection to a modem or router, which can correspond to the access point 25 itself in an example (e.g., for a WiFi router with both wired and wireless connectivity).

Referring to FIG. 1, a server 70 is shown as connected to the Internet 75, the core network 40, or both. The server 70 can be implemented as a plurality of structurally separate servers, or alternately may correspond to a single server. As will be described below in more detail, the server 70 is configured to support one or more communication services (e.g., Voice-over-Internet Protocol (VoIP) sessions, Push-to-Talk (PTT) sessions, group communication sessions, social networking services, etc.) for UEs that can connect to the server 70 via the core network 40 and/or the Internet 75, and/or to provide content (e.g., web page downloads) to the UEs.

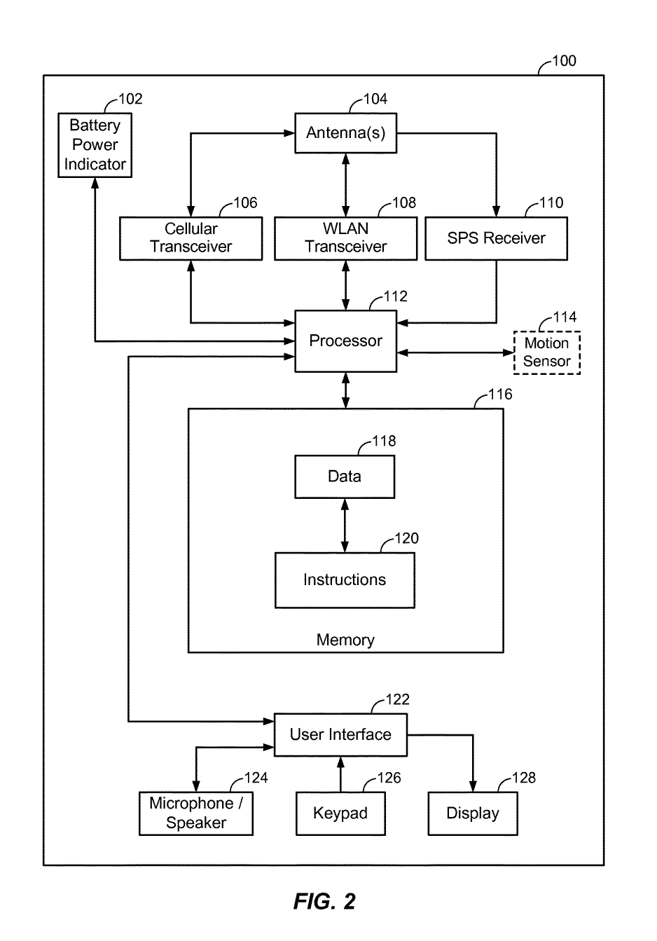

FIG. 2 is a block diagram illustrating an example of a mobile device 100. The mobile device 100 as shown in FIG. 2 may be a mobile phone, a smartphone, a handheld computer, a tablet, a wearable device, a smart watch, or any type of device capable of interacting with a user, for example. In the example shown in FIG. 2, the mobile device 100 may comprise a battery power indicator 102, one or more antennas 104, a cellular transceiver 106, a wireless local area network (WLAN) transceiver 108, such as a Wi-Fi transceiver, and a satellite positioning system (SPS) receiver 110. The SPS receiver 110 may be compatible with Global Positioning System (GPS), Global Navigation Satellite System (GLONASS), or any other global or regional satellite based positioning system. Furthermore, the mobile device 100 may include additional transceivers such as Bluetooth, ZigBee and other types of transceivers not shown in FIG. 2. Accordingly, the elements illustrated for the mobile device 100 are provided merely as an exemplary configuration and are not intended to limit the configuration of mobile devices in accordance with the various aspects disclosed herein.

In the example shown in FIG. 2, a processor 112 is coupled to the battery power indicator 102, the cellular transceiver 106, the WLAN transceiver 108 and the SPS receiver 110. Optionally, a motion sensor 114 and other sensors may also be coupled to the processor 112. A memory 116 is coupled to the processor 112. The memory 116 may include data 118 as well as stored instructions 120 to be executed by the processor 112 to perform the process steps according to embodiments of the disclosure.

Furthermore, the mobile device 100 may also include a user interface 122, which may include hardware and software for interfacing inputs or outputs of the processor 112 with the user through light, sound or tactile inputs or outputs, for example. In the example shown in FIG. 2, the mobile device 100 includes a microphone/speaker 124, a keypad 126, and a display 128 coupled to the user interface 122. Alternatively, the user's tactile input or output may be integrated with the display 128 by using a touch-screen display, for example. Once again, the elements illustrated in FIG. 2 are not intended to limit the configuration of the mobile devices disclosed herein, and it will be appreciated that the elements included in the mobile device 100 may vary based on the end use of the device and the design choices of system engineers.

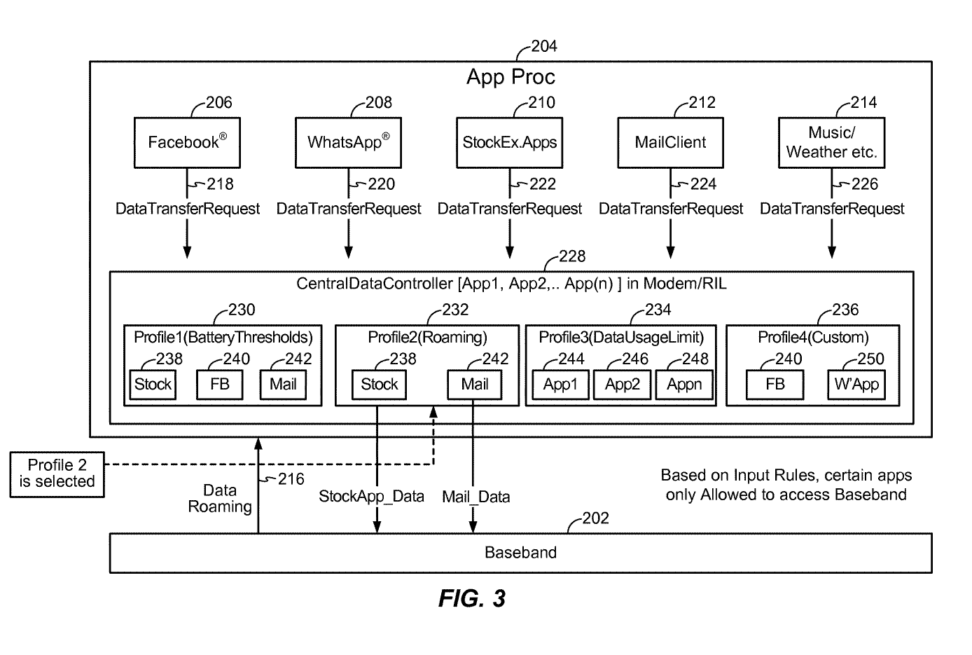

FIG. 3 is a block diagram illustrating one of many examples of profile-based data connection management for a mobile device that has various applications installed. In the example illustrated in FIG. 3, a baseband processor 202 is coupled to an application processor 204, which is capable of running a variety of applications, including, for example, Facebook® 206, WhatsApp® 208, one or more applications for stock quotes or stock exchange information 210, one or more applications for one or more mail clients 212, and one or more applications 214 for various other purposes such as downloading music, receiving weather forecasts, and so on. Various other types of applications may also be included within the scope of the disclosure.

When a mobile device is powered on or when an already powered-on mobile device enters a region where the mobile device user's home carrier is not available, for example, in a foreign country, the baseband processor 202, which may be an integral part of a radio transceiver, such as the cellular transceiver 106 or the WLAN transceiver 108 as shown in FIG. 2, or a modem coupled to such a radio transceiver, may send a data roaming notification 216 to the application processor 204, as shown in FIG. 3. In an embodiment, it is assumed that each of the applications in the mobile device, such as applications 206, 208, 210, 212 and 214 as shown in FIG. 3, has not been manually set by the user to disable automatic or periodic synchronization of data. As such, the applications 206, 208, 210, 212 and 214 are assumed to generate automatic data transfer requests 218, 220, 222, 224 and 226, respectively, in the application processor 204 when the mobile device is powered on, or at programmed time intervals if the applications 206, 208, 210, 212 and 214 are programmed to synchronize data periodically.

In an embodiment, a central data controller 228 is provided in the application processor 204 to allow or deny each of the data transfer requests 218, 220, 222, 224 and 226 from the applications 206, 208, 210, 212 and 214, respectively, based on one or more profiles, such as profiles 230, 232, 234 and 236 as illustrated in FIG. 3, in response to the data roaming notification 216 from the baseband processor 202. The profiles for allowing or denying data access by various applications may be provided in various manners. In an embodiment, the profiles for allowing or denying data access by various applications may be preprogrammed in the central data controller 228 before the mobile device is sold to the user. In a further embodiment, the profiles 230, 232, 234 and 236 may be modified or customized by the user according to the user's particular needs or preferences. For example, the mobile device user may be offered a default profile which may be activated either manually or automatically based one or more conditions.

In the example illustrated in FIG. 3, four profiles 230, 232, 234 and 236 are provided to allow or deny access based on certain types of conditions. For example, the first profile 230, which is a battery threshold profile, allows data access only by certain applications, for example, applications for stock quotes 238, Facebook® 240 and mail 242, if the battery power falls below a certain battery power threshold. In an embodiment, if the battery power measured by the batter power indicator 102 in FIG. 2, for example, is below the battery power threshold, then only those applications in the first profile 230 for battery threshold in FIG. 3 would be allowed to synchronize or transfer data while other applications not included in the battery threshold profile 230 would be denied data access. In an embodiment, applications that are not included in the battery threshold profile 230, i.e., applications that are not permitted to access the data connection based on the battery power threshold, comprise an unrestricted set of applications. In other words, the set of applications that are not included in the battery threshold profile 230 is not a closed set of a finite number of applications in this embodiment.

The second profile 232, which is a roaming profile, allows data access only by certain applications, for example, stock 238 and mail 242, if the mobile device is roaming. In an embodiment, an indication that the mobile device is roaming outside of the mobile device user's home carrier network is provided by the data roaming notification 216 from the baseband processor 202. The indication that the mobile device is roaming may also be provided in various other manners within the scope of the disclosure. In an embodiment, if the mobile device is roaming outside of the user's home carrier network, based on the data roaming notification 216 from the baseband processor 202, then only those applications in the roaming profile 232 in FIG. 3 would be allowed to synchronize or transfer data while other applications not included in the roaming profile 232 would be denied data access. In an embodiment, applications that are not included in the roaming profile 232 comprise an unrestricted set of applications. In other words, the set of applications that are not included in the roaming profile 232 is not a closed set of a finite number of applications in this embodiment.

As illustrated in FIG. 3, the profiles in the central data controller 228 may also include one or more additional profiles in order to control data usage by various applications in the mobile device. For example, the third profile 234, which is a data usage limit profile, allows data access only by certain applications, such as applications 244, 246 and 248, if the mobile device has exceeded a certain data usage limit in a given billing period. In an embodiment, the mobile device user may select applications that the user deems critical or important despite the prospect of incurring additional data usage costs, or applications that typically do not require a large amount of data transfer, for example, and enter those applications in the data usage limit profile 234. In an embodiment, if the mobile device has exceeded the data usage limit, then only those applications in the data usage limit profile 234 would be allowed to synchronize or transfer data while other applications not included in the data usage limit profile 234 would be denied data access. In an embodiment, applications that are not included in the data usage limit profile 234 comprise an unrestricted set of applications. In other words, the set of applications that are not included in the data usage limit profile 234 is not a closed set of a finite number of applications in this embodiment.

Moreover, the user may also create one or more additional profiles, such as a custom profile 236 which includes Facebook® 240 and WhatsApp® 250 as illustrated in FIG. 3, based on one or more conditions created or selected by the user. Such conditions may be based on criteria in addition to or other than the criteria for allowing or denying data access by applications in the battery threshold profile 230, the roaming profile 232, or the data usage limit profile 234, as shown in FIG. 3. For the custom profile 236, the user may set one more conditions for video downloading or video telephony, for example, based on one or more radio frequency (RF) condition thresholds or one or more application-wise data throughput thresholds. If the RF condition or data throughput makes video downloading or video telephony unacceptably slow, for example, if the available bandwidth for data downloading is less than 1 Mbps, video telephony or video downloading applications may be denied data access, thereby avoiding wasted data usage on unacceptably slow video connections.

In the example illustrated in FIG. 3, data roaming notification 216 is provided by the baseband processor 202 to the application processor 204, and upon receiving the data roaming notification 216, the roaming profile 232 in the central data controller 228 is selected, and only those applications included in the roaming profile 232 are allowed data access by the application processor 204. In alternate embodiments, an indication that the mobile device is roaming outside of the user's home carrier network may be provided in various other manners. In an embodiment, the central data controller 228, which stores the profiles 230, 232, 234 and 236, may be embedded as part of the application processor 204. In another embodiment, the central data controller 228 may be implemented as part of a modem, such as the baseband processor 202. In an embodiment, the central data controller 228 may be implemented in the Radio Interface Layer (RIL). Alternatively, the central data controller 228 may be implemented in another layer in a communication protocol within the scope of the disclosure. Although the roaming profile 232 may be selected based on an automatic roaming indication provided by the baseband processor 202, the roaming profile 232 may also be manually selected by the user when the user enters a foreign country, for example.

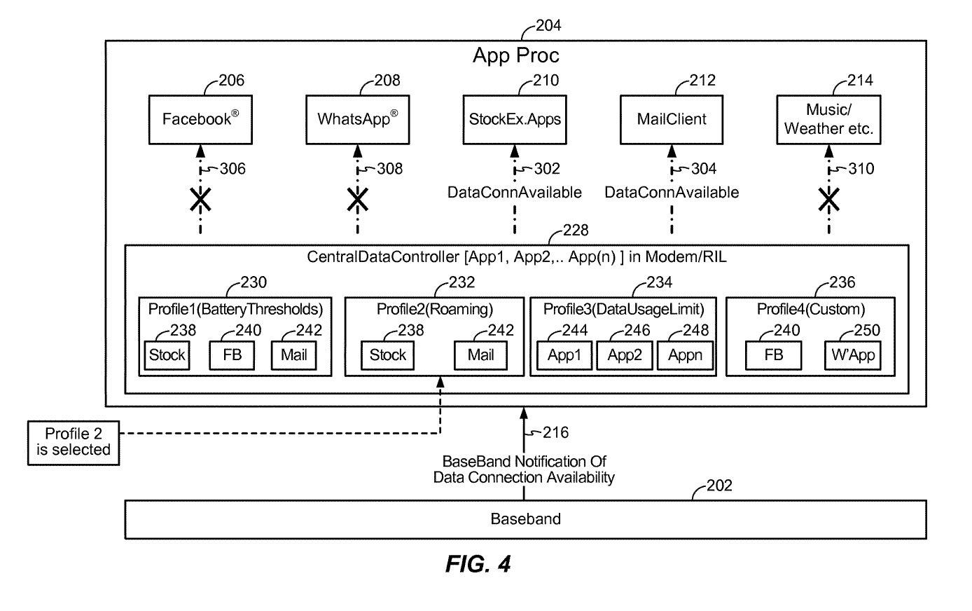

FIG. 4 is a block diagram illustrating an example of profile-based data connection management after the roaming profile 232 as shown in FIG. 3 has been selected. In FIG. 4, the roaming profile 232 is selected based on automatic data roaming notification 216 received from the baseband processor 202, or alternatively, selected by the user manually when the user knowingly enters a country or region where data access is only available through roaming. In addition to the data roaming indication 216, the baseband processor 202 may also indicate to the application processor 204 that data connection is available in the roaming network. Upon selection of the roaming profile 232, which includes only stock and mail applications 238 and 242 in the example shown in FIG. 4, the central data controller 228 sends indications 302 and 304 that data connections are available only to the applications 210 and 212 for stock quotes or stock exchange information and for one or more mail clients, respectively, as illustrated in FIG. 4.

On the other hand, applications that are not included in the roaming profile 232, such as the application 206 for Facebook®, the application 208 for WhatsApp®, and one or more applications 214 for music downloading or weather forecasts, are denied data access. In an embodiment, the central data controller 228 may send indications 306, 308 and 310 that data connections are denied to applications 206, 212 and 214, respectively, which are not listed in the roaming profile 232, to prevent those applications from synchronizing, updating or otherwise accessing data automatically when the mobile device is roaming. Data connection management using other profiles based on other criteria, for example, the battery threshold profile 230, the data usage limit profile 234 or the custom profile 236 in the data connection controller 228 as shown in FIG. 4, may also be performed to selectively allow or deny data access by each of the applications within the scope of the disclosure.

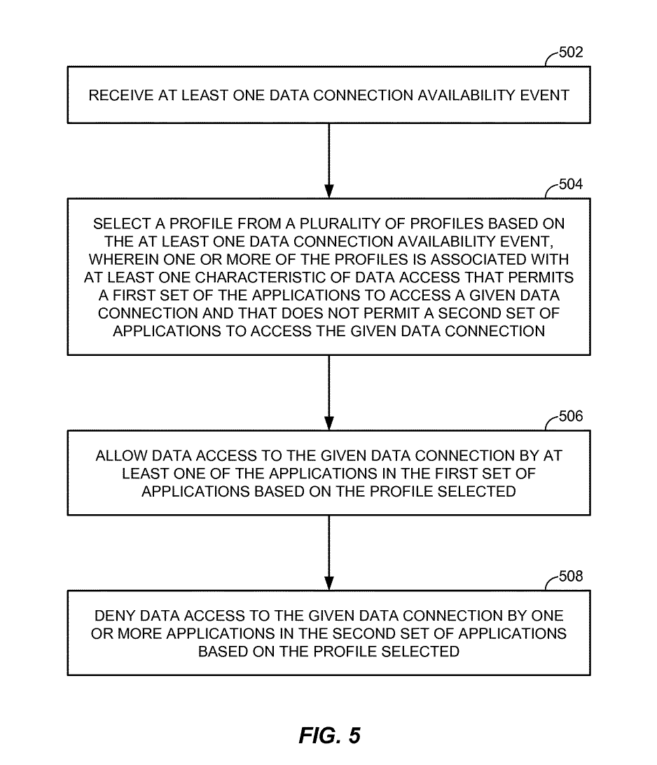

FIG. 5 is a flowchart illustrating an embodiment of a process of data connection management. In an embodiment, the mobile device receives at least one data connection availability event from a network in block 502. In an embodiment, a data connection availability event may be an indication that a roaming network is available and that data connection is available on the roaming network. A data roaming indication may be used by a central data controller 228 to select a roaming profile 232, for example, which allows data access only by those applications included in the roaming profile while denying data access to other applications when the mobile device is roaming, embodiments of which are described above with respect to FIGS. 3 and 4.

In another embodiment, the data connection availability events in block 502 as shown in FIG. 5 may include one or more data connection availability events other than a data roaming indication. For example, even if the mobile device is communicating with the home carrier network, it may still be desirable that some applications are allowed while others are denied data access based on conditions other than roaming. For example, as described above with respect to FIGS. 3 and 4, data connection management profiles based on conditions other than roaming may be created in the data connection controller 228, including, for example, a battery threshold profile 230, a data usage limit profile 234, or one or more custom profiles based on other conditions, such as the RF condition or data throughput thresholds for video telephony or video downloading.

Referring to FIG. 5, after the mobile device receives at least one data connection availability event in block 502, a profile is selected from a plurality of profiles based on the at least one data connection availability event in block 504. In an embodiment, each of the profiles is associated with at least one characteristic of data access, and each of the profiles includes one or more applications installed on the mobile device, as shown in block 504. In the embodiments described above with respect to FIGS. 3 and 4, these profiles may include a battery threshold profile 230, a data usage limit profile 234 or a custom profile 236, for example. The battery threshold profile 230, for example, may be associated with a battery power threshold based on whether large amounts of data transfer would prematurely drain the battery when the battery power level is below such a threshold. The data usage limit profile 234, for example, may be associated with a data usage limit threshold which the user is not expected to exceed in a given billing period. Custom profile 236 may be based on criteria associated with other data access characteristics. For example, video downloading or video telephony applications may be denied access if the data throughput or bandwidth falls below a certain threshold.

Referring to FIG. 5, after the profile is selected based on at least one data connection availability event in block 504, the mobile device allows data access by at least one of the applications based on the profile selected in block 506. For example, if the profile selected is a roaming profile, then only those applications included in the roaming profile are allowed data access. Furthermore, as illustrated in FIG. 5, based on the profile selected, one or more applications other than at least one of the applications included in the selected profile are denied data access, as shown in block 508. For example, if the profile selected is a roaming profile, then all applications not included in the roaming profile are denied data access, such that the user may avoid expensive data usage charges when the mobile device is roaming.

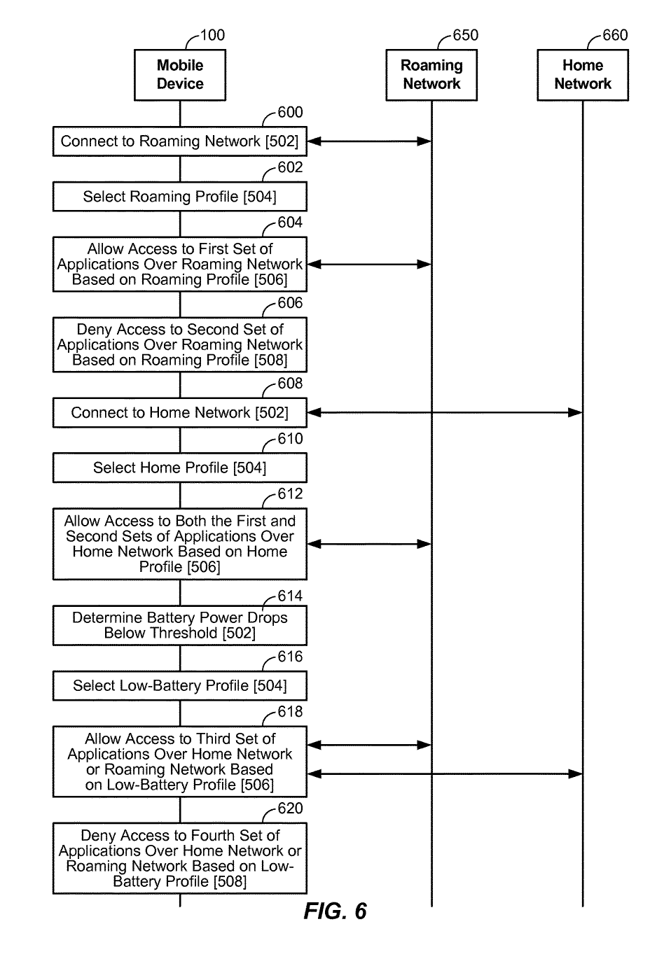

FIG. 6 is a diagram illustrating an embodiment of profile transitions in data connection management between a mobile device 100 and a roaming network 650 or home network 660. Although FIG. 6 illustrates process steps described in blocks 600-620, it is not necessary to perform any of these steps in a particular order. In the embodiment shown in FIG. 6, the mobile device 100 connects to a roaming network 600 and receives a data connection availability event, which in this instance is a roaming event. In response to the roaming event triggered by the connection to the roaming network in block 600, a roaming profile is selected in block 602.

After the roaming profile is selected in block 602, the processor in the mobile device 100 allows access to the first set of applications over the roaming network 650 in block 604. In an embodiment, a second set of applications that are not permitted by the roaming profile to access a roaming network is denied access to the roaming network 650 in block 606. In an embodiment, the second set of applications may include any applications that are not specifically allowed by the roaming profile to access data while the mobile device is roaming.

In an embodiment, the mobile device 100 is connected to the home network 660 in block 608. In a further embodiment, a home profile may be provided in block 610, and applications in both the first and second sets of applications are allowed access to the home network 660 based on the home profile in block 612. In an embodiment, regardless of whether the mobile device 100 is connected to the home network 660 or the roaming network 650, access to applications may be restricted if the battery power is below a threshold. For example, as illustrated in FIG. 6, a determination may be made as to whether the battery power drops below a certain threshold in block 614. Such a determination may also be part of the data connection availability event as shown in block 602 in FIG. 5.

Referring to FIG. 6, after the battery power is determined in block 614, a low-battery profile is selected in block 616. In an embodiment, in response to a determination that the battery power is below a certain threshold, a third set of applications are allowed access over the home network 660 or the roaming network 650 based on the low-battery profile in block 618. Applications that are permitted access in the low-battery profile may include mission-critical applications such as emails, for example. In an embodiment, a fourth set of applications are denied access based on the low-battery profile in block 620. The fourth set of applications may include applications that are not considered mission-critical, for example. One or more additional profiles that restrict certain applications from accessing home or roaming networks based on other conditions, such as the data usage limit described above with respect to FIG. 3 or 4, or other customized profiles may also be included and used for determining whether access by certain applications to a network is allowed or denied in a similar manner to the examples of roaming profile and low-battery profile illustrated in FIG. 6.

In an embodiment, a mobile device having a memory and a processor comprising logic configured to perform embodiments of process steps in any of the methods described above is provided. In an embodiment, the processor in the mobile device comprises logic configured to perform the process steps described above with respect to FIG. 5 or 6, including logic configured to receive at least one data connection availability event, logic configured to select a profile from a plurality of profiles based on the at least one data connection availability event, wherein one or more of the profiles is associated with at least one characteristic of data access that permits a first set of the applications to access a given data connection and that does not permit a second set of applications to access the given data connection, logic configured to allow data access to the given data connection by at least one of the applications in the first set of applications based on the profile selected, and logic configured to deny data access by one or more applications other than the at least one of the applications based on the profile selected. In an embodiment, the logic configured to perform these functions may be implemented in one or more processors, including, for example, the processor 112 in the mobile device 100 as shown in FIG. 2, or the baseband processor 202, the application processor 204, or the central data controller 228 as shown in FIG. 3 or 4.

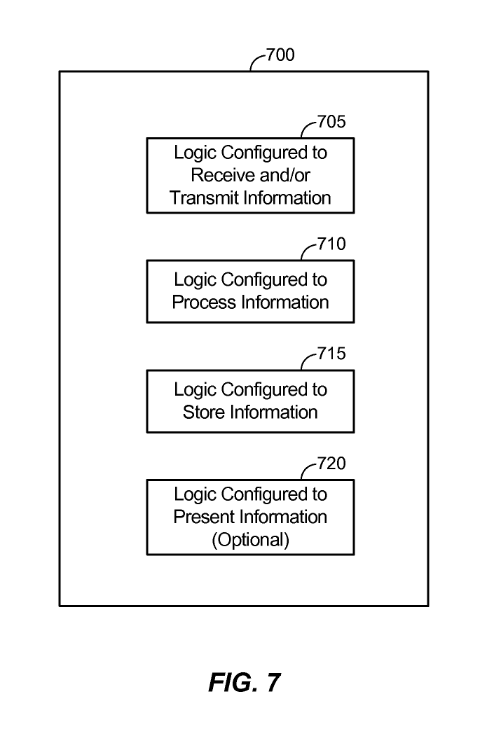

FIG. 7 illustrates a communication device 700 that includes logic configured to perform functionalities in the embodiments described above. Referring to FIG. 7, the communication device 700 includes logic configured to receive and/or transmit information 705. For example, if the communication device 700 corresponds to a wireless communications device (e.g., UE 1 . . . UE N in FIG. 1), the logic configured to receive and/or transmit information 705 may include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). The logic configured to receive and/or transmit information 705 may also include but is not limited to software that, when executed, permits the associated hardware of the logic configured to receive and/or transmit information 705 to perform its reception and/or transmission function(s).

Referring to FIG. 7, the communication device 700 further includes logic configured to process information 710. For example, the logic configured to process information 710 may include at least a processor. Example implementations of the type of processing that can be performed by the logic configured to process information 710 includes but is not limited to performing determinations, establishing connections, making selections between different information options, performing evaluations related to data, interacting with sensors coupled to the communication device 700 to perform measurement operations, converting information from one format to another (e.g., between different protocols such as .wmv to .avi, etc.), and so on. For example, the processor included in the logic configured to process information 710 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 710 may also include but is not limited to software that, when executed, permits the associated hardware of the logic configured to process information 710 to perform its processing function(s).

Referring to FIG. 7, the communication device 700 further includes logic configured to store information 715. In an example, the logic configured to store information 715 may include at least a non-transitory memory and associated hardware (e.g., a memory controller, etc.). For example, the non-transitory memory included in the logic configured to store information 715 may correspond to RAM memory, flash memory, ROM memory, EPROM memory, EEPROM memory, registers, hard disk, a removable disk, a CD-ROM, or any other form of storage medium known in the art. The logic configured to store information 715 may also include but is not limited to software that, when executed, permits the associated hardware of the logic configured to store information 715 to perform its storage function(s).

Referring to FIG. 7, the communication device 700 may further include logic configured to present information 720. For example, the logic configured to present information 720 may include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 700. The logic configured to present information 720 may also include but is not limited to software that, when executed, permits the associated hardware of the logic configured to present information 720 to perform its presentation function(s). In an embodiment, the logic 705, 710, 715 and 720 configured to perform the above-described functions in the communication device 700 may be implemented in one or more processors, including, for example, the processor 112 in the mobile device 100 as shown in FIG. 2, or the baseband processor 202, the application processor 204, or the central data controller 228 as shown in FIG. 3 or 4.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the disclosure can include a computer readable media embodying a method for selectively controlling data access by a mobile device having a plurality of applications stored therein. Accordingly, the disclosure is not limited to illustrated examples and any means for performing the functionality described herein are included in embodiments of the disclosure.

While the foregoing disclosure shows illustrative embodiments, it should be noted that various changes and modifications could be made herein without departing from the scope of the appended claims. The functions, steps, or actions of the method claims in accordance with embodiments described herein need not be performed in any particular order unless expressly stated otherwise. Furthermore, although elements may be described or claimed in the singular, the plural is contemplated unless limitation to the singular is explicitly stated.

What is claimed is:

1. A method of selectively controlling data access by a mobile device having a plurality of applications stored therein, the method comprising:
receiving at least one data connection availability event;
selecting a profile from a plurality of profiles based on the at least one data connection availability event, wherein one or more of the profiles is associated with at least one characteristic of data access that permits a first set of the applications to access a given data connection and that does not permit a second set of applications to access the given data connection;
allowing data access to the given data connection by at least one of the applications in the first set of applications based on the profile selected; and
denying data access to the given data connection by at least one of the applications in the second set of applications based on the profile selected.

2. The method of claim 1, wherein the second set of applications that are not permitted to access the given data connection in at least one of the profiles comprises an unrestricted set of applications.

3. The method of claim 2, wherein the at least one data connection availability event corresponds to the mobile device having an availability to communicate by roaming.

4. The method of claim 3, wherein the receiving at least one data connection availability event comprises receiving a roaming notification from a baseband processor.

5. The method of claim 4, wherein the profiles include a roaming profile that includes at least one application that is allowed data access when the mobile device is roaming.

6. The method of claim 5, wherein the allowing data access to the given data connection by at least one of the applications in the first set of applications based on the profile selected comprises allowing data access by the at least one application in the roaming profile.

7. The method of claim 1, wherein the at least one data connection availability event corresponds to the mobile device having a battery power that is below a battery power threshold.

8. The method of claim 7, wherein the profiles include a battery threshold profile that includes at least one application that is allowed data access when the battery power of the mobile device is below the battery power threshold.

9. The method of claim 8, wherein the allowing data access to the given data connection by at least one of the applications in the first set of applications based on the profile selected comprises allowing data access by the at least one application in the battery threshold profile.

10. The method of claim 1, wherein the at least one data connection availability event corresponds to the mobile device having a data usage that exceeds a data usage limit

11. The method of claim 10, wherein the profiles include a data usage limit profile that includes at least one application that is allowed data access when the data usage of the mobile device exceeds the data usage limit.

12. The method of claim 11, wherein the allowing data access to the given data connection by at least one of the applications in the first set of applications based on the profile selected comprises allowing data access by the at least one application in the data usage limit profile.

13. A mobile device having a plurality of applications stored therein, the wireless device comprising:
means for receiving at least one data connection availability event;
means for selecting a profile from a plurality of profiles based on the at least one data connection availability event, wherein one or more of the profiles is associated with at least one characteristic of data access that permits a first set of the applications to access a given data connection and that does not permit a second set of applications to access the given data connection;
means for allowing data access to the given data connection by at least one of the applications in the first set of applications based on the profile selected; and
means for denying data access to the given data connection by at least one of the applications in the second set of applications based on the profile selected.

14. The mobile device of claim 13, wherein the at least one data connection availability event corresponds to the mobile device having an availability to communicate by roaming.

15. The mobile device of claim 14, wherein the profiles include a roaming profile that includes at least one application that is allowed data access when the mobile device is roaming, and wherein the means for allowing data access to the given data connection by at least one of the applications in the first set of applications based on the profile selected comprises means for allowing data access by the at least one application in the roaming profile.

16. The mobile device of claim 13, wherein the at least one data connection availability event corresponds to the mobile device having a battery power that is below a battery power threshold.

17. The mobile device of claim 16, wherein the profiles include a battery threshold profile that includes at least one application that is allowed data access when the battery power of the mobile device is below the battery power threshold, and wherein the means for allowing data access to the given data connection by at least one of the applications in the first set of applications based on the profile selected comprises means for allowing data access by the at least one application in the battery threshold profile.

18. The mobile device of claim 12, wherein the at least one data connection availability event corresponds to the mobile device having a data usage that exceeds a data usage limit.

19. A non-transitory computer readable medium in a mobile device having a plurality of applications stored therein, the non-transitory computer readable medium comprising instructions for causing a processor to perform operations, the instructions comprising:
instructions to receive at least one data connection availability event;
instructions to select a profile from a plurality of profiles based on the at least one data connection availability event, wherein one or more of the profiles is associated with at least one characteristic of data access that permits a first set of the applications to access a given data connection and that does not permit a second set of applications to access the given data connection;
instructions to allow data access to the given data connection by at least one of the applications in the first set of applications based on the profile selected; and
instructions to deny data access to the given data connection by at least one of the applications in the second set of applications based on the profile selected.

20. The non-transitory computer readable medium of claim 19, wherein the at least one data connection availability event corresponds to the mobile device having an availability to communicate by roaming.

21. The non-transitory computer readable medium of claim 19, wherein the at least one data connection availability event corresponds to the mobile device having a battery power that is below a battery power threshold.

22. The non-transitory computer readable medium of claim 19, further comprising instructions to determine whether data usage by the mobile device exceeds a data usage limit.

23. A mobile device having a plurality of applications stored therein, the mobile device comprising:
a memory; and
a processor coupled to the memory, the processor comprising:
logic configured to receive at least one data connection availability event;
logic configured to select a profile from a plurality of profiles based on the at least one data connection availability event, wherein one or more of the profiles is associated with at least one characteristic of data access that permits a first set of the applications to access a given data connection and that does not permit a second set of applications to access the given data connection;
logic configured to allow data access to the given data connection by at least one of the applications in the first set of applications based on the profile selected; and
logic configured to deny data access to the given data connection by at least one of the applications in the second set of applications based on the profile selected.

24. The mobile device of claim 23, wherein the second set of applications that are not permitted to access the given data connection in at least one of the profiles comprises an unrestricted set of applications.

25. The mobile device of claim 23, wherein the at least one data connection availability event corresponds to the mobile device having an availability to communicate by roaming.

26. The mobile device of claim 25, wherein the profiles include a roaming profile that includes at least one application that is allowed data access when the mobile device is roaming, and wherein the logic configured to allow data access to the given data connection by at least one of the applications in the first set of applications based on the profile selected comprises logic configured to allow data access by the at least one application in the roaming profile.

27. The mobile device of claim 23, wherein the at least one data connection availability event corresponds to the mobile device having a battery power that is below a battery power threshold.

28. The mobile device of claim 27, wherein the profiles include a battery threshold profile that includes at least one application that is allowed data access when the battery power of the mobile device is below the battery power threshold, and wherein the logic configured to allow data access to the given data connection by at least one of the applications in the first set of applications based on the profile selected comprises logic configured to allow data access by the at least one application in the battery threshold profile.

29. The mobile device of claim 23, wherein the at least one data connection availability event corresponds to the mobile device having a data usage that exceeds a data usage limit.

30. The mobile device of claim 29, wherein the profiles include a data usage limit profile that includes at least one application that is allowed data access when the data usage of the mobile device exceeds the data usage limit, and wherein the logic configured to allow data access to the given data connection by at least one of the applications in the first set of applications based on the profile selected comprises logic configured to allow data access by the at least one application in the data usage limit profile.
